(19) United States
(12) Patent Application Publication
(10) Pub. No.: US 2004/0111170 A1
(43) Pub. Date: Jun. 10, 2004

(54) Free market playoff system and methods thereof

(76) Inventor: Michael J. Hasday, Arlington, VA (US)

Correspondence Address: Carl A. Giordano, Duane Morris LLP, 380 Lexington Avenue, New York, NY, 10168, US

(21) Appl. No.: 10/634,053

(22) Filed: Aug. 4, 2003

Related U.S. Application Data
(60) Provisional application No. 60/431,596, filed on Dec. 6, 2002.

(51) Int. Cl. G06F 155/00

(52) U.S. Cl. 700/91

(57) ABSTRACT

A method and system for determining a winner in a competitive event among a plurality of competitors or participants is disclosed. In one aspect of the invention, each of the participants is provided a ranking or seed value that is used to determine the order of selection of a competitive partner. In another aspect of the invention, only half of the competitors or participants have, receive, or are assigned a rank or seed value. Competitors or participants with a higher ranking or seed value may select their competitive partner from among the plurality of competitors having a lower ranking, a lower seed value or no ranking or seed value. Each of the competitive partners competes in the event and the winning partner proceeds to the next round of competition. In one aspect of the invention, each winning participant maintains its ranking or seed value into the next round of competition. In another aspect of the invention, each winning participant obtains the higher ranking or seed value between the competitive partners. In still another aspect of the invention, each winning participant obtains a new ranking or seed value based on its performance within a competitive round.

### CLAIM OF PRIORITY

This application claims the benefit of the earlier filing date, pursuant to 35 USC § 119, of commonly-owned:

U.S. Provisional Patent Application Serial No. 60/431,596 entitled “Method and System for Organizing Competitive Events,” filed on Dec. 6, 2002, the whole of which is incorporated by reference herein.

### FIELD OF THE INVENTION

The present invention relates to competitive sporting events and more specifically to methods for organizing competitive events to increase their interest.

### BACKGROUND

“Any team can beat any other team on any given Sunday” is a football adage that sparks the competitive spirit in every competitive team. During competition, the aggregate of some undetermined factors contribute to a superior performance by a vastly out-matched team to enable the team to overcome its competitor's superiority and win the game. Similar adages may be applied to baseball, basketball, soccer and other such competitive events. To insure that the best teams eventually compete against one another, the principle of almost all sporting or similar competitive events is that those teams that accumulate the best records are allowed entry into a series of playoff games. The playoff teams are generally seeded based on their success in the regular season, with the most successful regular season team designated as the No. 1 seed, the second-most successful regular season team designated as the No. 2 seed and so on until the least successful regular season team that qualified for the playoffs is designated as the lowest seed. In the first round of the playoffs, the No. 1 seeded team generally faces the lowest seeded team; the No. 2 seeded team faces the second-lowest seeded team, and so on until all the teams are paired. The team accumulating the best record in their respective series of playoff games then proceeds on to the next level of the playoffs, in which the teams are paired similarly, and this process continues until one team is eventually crowned as the champion of the season.

However, during the course of a season, a team may achieve a sufficient record of game wins to be mathematically guaranteed entry to the series playoffs. In this case, the team may elect to rest its primary players and use players with less experience, as the loss of any future games is immaterial, or penalized insufficiently. This strategy of coasting to the playoffs is not irrational, as it is not necessary to play every game as if it were a “make or break” game. Furthermore, there is no need to risk injury or burnout to the star players when the sole reward may be an extra home game. For example, many commentators have suggested that in the 2001-2002 National Basketball Association (NBA) season, the Los Angeles Lakers did not go all-out to win every regular season game, secure in the knowledge that it could “turn it on” in the playoffs. These commentators believed that the Lakers' ability to succeed in the playoffs was greater than its No. 3 seed position that year, and were proved correct as the Lakers won the 2001-2002 NBA Championship.

Moreover, a team's ability to succeed in the playoffs may be significantly better or worse than its seed position even if the team tries its hardest to win every single regular season game. An injury to a key player, a return of a key player from injury, a late-season trade or departure, the fast development of a young player late in the season, late-season momentum and/or other factors may make a team's playoff seed a less than reliable indicator of a team's ability to succeed in the playoffs.

Furthermore, even if a seed were a reliable indicator of a team's ability to succeed in the playoffs, some inferior teams present specific “match-up” problems for a superior team. For example, an inferior team with one superstar player may present match-up problems for a superior team whose weakest defensive player is responsible for defending that superstar's position.

For these reasons, there is a significant lack of certainty that the playoff match-ups will be distributed such that the No. 1 seed would be matched against the playoff opponent that the No. 1 seed would have the best chance of defeating (i.e. the easiest opponent for the No. 1 seed). Similarly, there is a significant lack of certainty that the No. 2 seed would be matched against the playoff opponent that the No. 2 seed would have the best chance of defeating, with the exception of the playoff opponent that is matched against the No. 1 seed.

Since there is this significant lack of certainty that the playoff match-ups will be efficiently distributed, there is less incentive for teams to compete for the top seeds. In fact, a team that finishes with a top seed may actually be put at a disadvantage due to its regular season success. For example, in the 1998-1999 NBA season, the Miami Heat had a superb regular season with 33 wins and 17 losses and was deemed to be the number one-seeded team in the Eastern Conference. However, in a first-round playoff contest, the resurgent New York Knicks presented a terrible match-up for the Heat. The Knicks, seeded as number eight, promptly defeated the Heat in five games en route to the NBA finals. The Heat, for all its effort in achieving high performance levels during the regular season, had a long summer to ponder how all its success in the regular season meant nothing.

Consequently, the top teams have an increased incentive to employ the “coasting” strategy as described above. Similarly, a team may avoid winning a last game to prevent a subsequent match-up with a significantly superior team in the first round of playoffs. Further still, as the selection or “draft” of the next group of eligible players is often determined by the regular season record, a team may similarly position itself to obtain a record that allows it to select early in the selection process, but still allow entry into the playoffs.

However, sport fans are deprived of the outstanding playing efforts of the team's star players, as the coaches are altering their game plans in anticipation of future benefits derived from a favorable playoff position. Thus, the excitement and the expectation of such competitive events is significantly lower as the fans and the media, knowing the coasting game plan, lose interest in the events until the playoffs begin. Moreover, when the best teams have less than stellar regular season records but subsequently advance far in the playoffs, fans may lose interest in the regular season as the connection between winning regular season games and winning the championship becomes less apparent. Consequently, a sports league may decide to severely limit the number of teams that are permitted to compete in the playoffs in order to keep the regular season games meaningful. But in doing so, the sports leagues are depriving fans in some cities of the belief that their team has an opportunity to make the playoffs, as well as the extra revenue that additional playoff games provide.

Finally, when a team clinches a playoff spot, fans and the media enjoy debating who would be the easiest first-round playoff match-up for the “home” team. However, the interest of this debate is limited as teams have no direct control over the opponent that they face.

Furthermore, when players on teams that have just clinched a playoff spot are asked about which team they would prefer to face, players often respond that it doesn't matter to them. Players have an incentive to use this response because they have no reason to provide a “bulletin board quote” for a would-be opponent. However, such a response depresses interest in the playoffs as there is no “revenge” story line of Team A facing Team B, which has specifically and publicly stated that it wanted to face Team A.

Accordingly, there is a need for a system for the selection of playoff competitive event partners that provides incentives to those teams that achieve high performance levels during the regular season, while providing a disincentive to those teams that relax or ease their efforts during the regular season. There is also a need for a playoff system that will increase interest by stirring debate among the media, fans, players, and team organizations about which playoff teams match up best and worst with the top seeds.

### SUMMARY

A method and system for determining a winner in a competitive event among a plurality of competitors or participants that provides an incentive to achieve high levels of performance during the regular season is disclosed. In one aspect of the invention, each of the participants is provided a ranking or seed value that is used to determine the order of selection of a competitive partner. In another aspect of the invention, only half of the competitors or participants receive or are assigned a rank or seed value. Competitors or participants with a higher ranking or seed value may select their competitive partner from among the plurality of competitors having a lower ranking or seed value. Each of the competitive partners competes in the event and the winning partner proceeds to the next round of competition. In one aspect of the invention, each winning participant maintains its ranking or seed value into the next round of competition. In another aspect of the invention, each winning participant obtains the higher ranking or seed value between the competitive partners. In still another aspect of the invention, each winning participant obtains a new ranking or seeding value based on its performance within a competitive round.

### BRIEF DESCRIPTION OF THE DRAWINGS

In the drawings:

FIG. 1 illustrates a flow chart of an exemplary process in accordance with the principles of the invention;

FIG. 2 illustrates a flow chart of one aspect of an exemplary process for selecting competitive partners in accordance with the principles of the invention;

FIG. 3 illustrates a flow chart of a second aspect of an exemplary process for selecting competitive partners in accordance with the principles of the invention; and

FIG. 4 illustrates a system for selecting competitive partners in accordance with the principles of the invention.

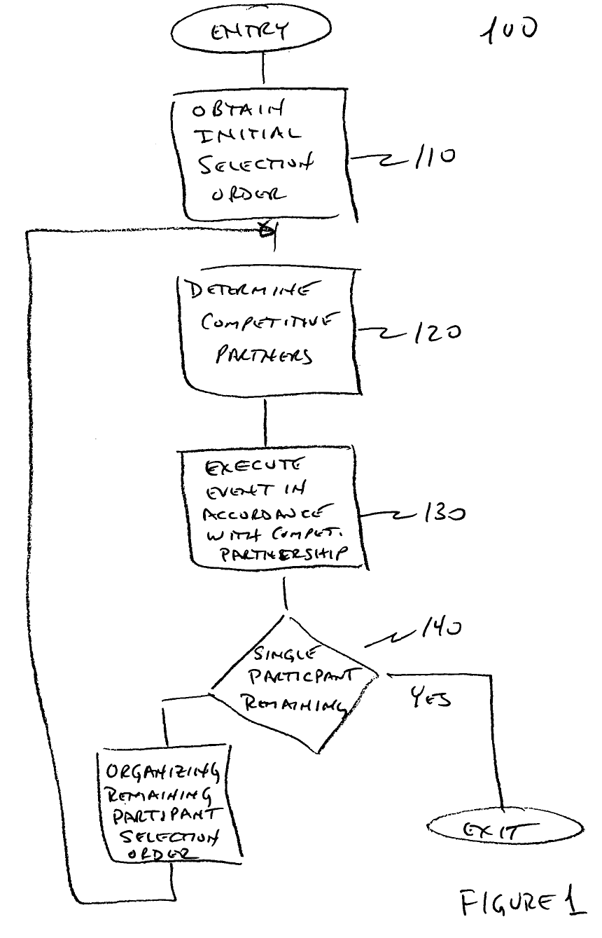

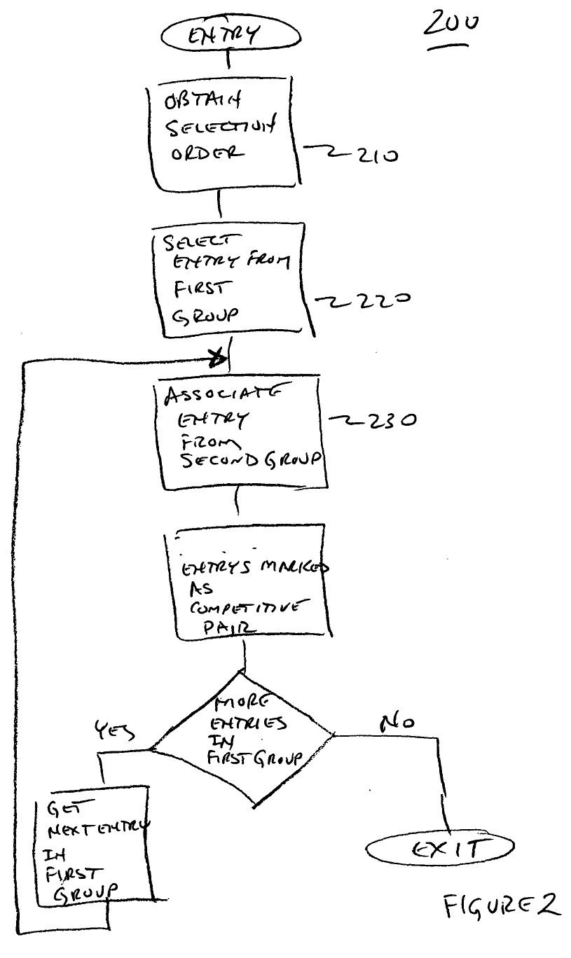

It is to be understood that these drawings are solely for purposes of illustrating the concepts of the invention and are not intended as a definition of the limits of the invention. The embodiments shown in FIGS. 1 through 4 and described in the accompanying detailed description are to be used as illustrative embodiments, and should not be construed as the only manner of practicing the invention. It is to be understood that these drawings are for purposes of illustrating the concepts of the invention and are not to scale. Also, the same reference numerals, possibly supplemented with reference characters where appropriate, have been used to identify similar elements.

### DETAILED DESCRIPTION

FIG. 1 illustrates a flow chart of an exemplary process 100 for determining a winning competitor in accordance with the principles of the invention. In this exemplary process, an initial selection order of at least half of the participants is obtained at block 110. For example, selection order may be based on factors such as past performance in comparison to past performance of other participants, past performance in comparison to the past performance of a subset of the other participants, a computer formula, the judgment of event organizers or combinations thereof. At block 120, the organization of the competitive partners is determined. At block 130, the competitive events, e.g., football, baseball, basketball, soccer, rowing, shooting, etc., using the determined competitive partners, are executed. At block 140, a determination is made whether a single competitor or participant is indicated as having successfully beaten each correspondingly selected competing partner. If the answer is in the affirmative, then the process is ended. However, if the answer is negative, then a new selection order is determined at block 150 and processing continues at block 120 until a single competitor is determined to have beaten each correspondingly selected competing partner.

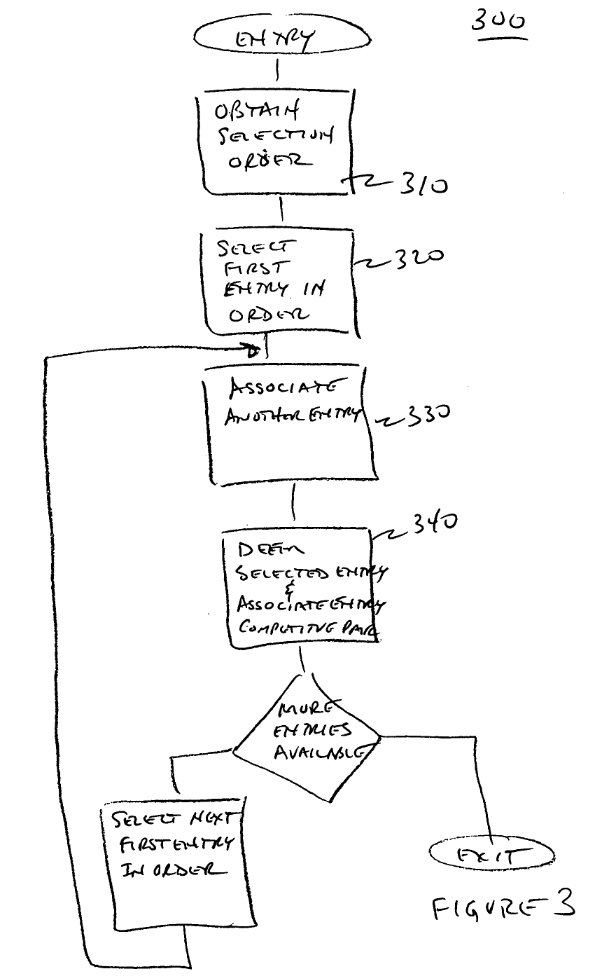

FIG. 2 illustrates a flow chart of a first aspect of an exemplary process 200 for selecting competitive partners. In this aspect of the invention, the participant selection order is obtained at block 210. At block 220, a competitor is selected from a first group of participants. This first group may consist of at least half of the participants rated, ranked, or seeded the highest among the participants or competitors. At block 230, the selected competitor from the first group is associated with an entry from a second group of participants or competitors to form a competitive pair for the current round of events. In one aspect of the invention, this second group consists of the remaining participants, who may or may not be ranked, rated or seeded.

At block 240, the selected competitor partners are removed from the further selection in the current round. At block 250, a determination is made whether more competitors remain in the first group. If the answer is in the negative, then each of the competitors has been paired or partnered and processing ends. However, if the answer is in the affirmative, then a next competitor in the first group is selected at block 160. Processing then continues at block 230 until each of the competitors has been paired or partnered.

In one aspect, the order of selection of competitors within the first group may be determined based on ranking, rating or seed. In another aspect, the order of selection of competitors within the first group may be based on drawing, lottery, or other similar probabilistic methods.

As an example of the process described, in a first round of the competitive event, each of the participants seeded in the top half selects its opponent from participants seeded in the bottom half, with each participant selecting in order of its placement or seed value. The winners of the first round contests (which may include games or series of games) move on to the second round of the event, while the losers of the first round contests are eliminated. In the second round of the event, each of the participants seeded in the top half selects its opponent from participants seeded in the bottom half, with each participant selecting in order of its placement or seed value. The winners of the second round contests move on to the third round of the event, if sufficient competitors remain, while the losers of the second round contests are eliminated. This pattern continues until only two participants are left, which then compete to determine the winner of the event.

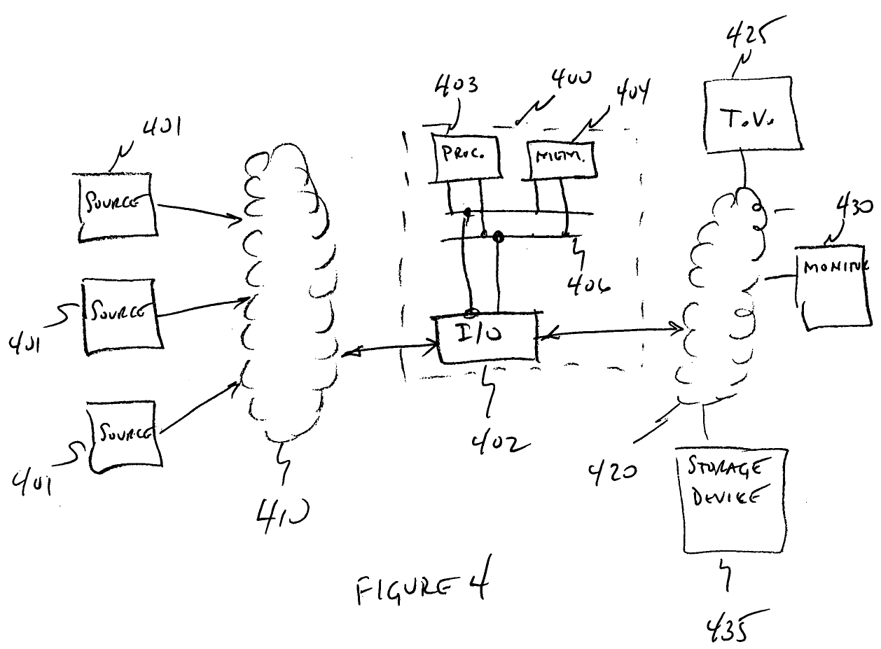

FIG. 3 illustrates a flow chart of a second aspect of an exemplary process 300 for selecting competitive partners. In this aspect of the invention, the participant selection order is obtained at block 310. At block 310, a competitor is selected. At block 330, the selected competitor is associated with any of the remaining participants or competitors to form a competitive pair for the current round of events. At block 340, the selected competitive partners are removed from the further selection in the current round. At block 350, a determination is made whether more competitors remain. If the answer is in the negative, then each of the competitors has been paired or partnered and processing ends. However, if the answer is in the affirmative, then a next remaining competitor is selected at block 360. Processing then continues at block 330 until each of the competitors has been paired or partnered.

In one aspect, the order of selection of competitors may be determined based on ranking, rating or seed. In another aspect, the order of selection of competitors may be based on drawing, lottery, or other similar probabilistic methods, as previously described.

Examples of the operation of the present invention are now disclosed: In this initial eight team example, eight teams are ranked based on the teams' performance or records during the regular season. The order of the teams is as follows:

1. Miami

2. Indiana

3. Milwaukee

4. Detroit

5. Cleveland

6. New York

7. New Jersey

8. Chicago

For the first round of the playoffs, Miami, the No. 1 seed, can select its first-round opponent from the fifth to eighth seeds (the bottom half of the seeds). In this example, Miami chooses or is associated with New Jersey, the No. 7 seed.

Indiana, the No. 2 seed, can select the team it would want to face from the teams remaining from the bottom half of the seeds—either Cleveland (No. 5 seed), New York (No. 6 seed), or Chicago (No. 8). In this example, Indiana chooses to play or is associated with Chicago, the No. 8 seed.

Milwaukee, the No. 3 seed, can select the team it would want to face from the teams remaining from the bottom half of the seeds—either Cleveland (No. 5 seed) or New York (No. 6 seed). Milwaukee chooses Cleveland.

Detroit, the No. 4 seed, can select the team it would want to face from the teams remaining from the bottom half of the seeds—in this case, only New York, the No. 6 seed, is remaining. Thus, Detroit chooses to play New York.

Assuming now that in a game or series of games:

New Jersey defeats Miami

Indiana defeats Chicago

Milwaukee defeats Cleveland

Detroit defeats New York

Consequently, the four seeds remaining are:

New Jersey, the No. 7 seed

Indiana, the No. 2 seed

Milwaukee, the No. 3 seed

Detroit, the No. 4 seed

Thus, the two top seeds that are remaining are Indiana (No. 2) and Milwaukee (No. 3). Therefore, Indiana, the top seed remaining, can select either team from the bottom half of the remaining seeds: Detroit, the No. 4 seed or New Jersey, the No. 7 seed. For purposes of continuing this example, Indiana selects, is associated with or is a competitive partner to New Jersey.

Milwaukee, the No. 3 seed, thus plays the only remaining team in the bottom half of the seeds, which in this case is Detroit, the No. 4 seed.

Assuming now that in this second round of events New Jersey defeats Indiana and Milwaukee defeats Detroit. In this case, as only two teams are left, New Jersey will play Milwaukee for the championship. Assuming that in the next round of competitive events, Milwaukee defeats New Jersey, then Milwaukee is deemed the winner of the competitive event.

In one alternative embodiment of the invention, the invention disclosed may be concurrently or non-concurrently executed in two or more simultaneous tournaments, with the winners of each tournament participating in a competition, which may or may not use the invention disclosed, to determine the winner of the event. For example, the NBA is comprised of two conferences. The invention disclosed may be used to determine the winner in either or both conferences. The two conference winners would then compete against each other in the NBA championship.

For example, in the initial eight team example above, assume that Milwaukee became the winner of the Eastern Conference using the invention disclosed. A different eight-team tournament, following the same procedure, produced a Western Conference champion, e.g., Los Angeles. Then, Milwaukee will play Los Angeles for the overall championship of the tournament.

Alternatively, the invention disclosed may be executed in one or more tournaments concurrently or non-concurrently to one or more tournaments that do not use the invention disclosed. The winners of each tournament would then participate in a competition, which may or may not use the invention disclosed, to determine the winner of the event. For example, the NBA is comprised of the Eastern Conference and the Western Conference. The invention disclosed may be used to determine the winner of the Eastern Conference, while the invention disclosed may not be used to determine the winner of the Western Conference. The two conference winners would then compete against each other in the NBA Championship.

In another example, in the initial eight team example above, assume that Milwaukee became the winner of the Eastern Conference using the invention disclosed. A different eight-team tournament that does not use the invention disclosed produces a Western Conference champion—let's assume it is again Los Angeles. Thus, Milwaukee will play Los Angeles for the overall championship of the tournament.

In still another alternative embodiment of the invention, after a first round, if a participant defeats a participant with a higher seed, then the winning participant may obtain the higher seed or ranking of the opponent for purposes of the next round. In this case, the order of selection may be significantly altered.

With reference to the initial eight team example above, in this alternative embodiment, since New Jersey, the No. 7 seed, defeated Miami, the No. 1 seed, New Jersey would become the No. 1 seed. Under this variation, the four participants remaining, and their order of selection, would be:

New Jersey, the No. 1 seed

Indiana, the No. 2 seed

Milwaukee, the No. 3 seed

Detroit, the No. 4 seed

Thus, the two top seeds that are remaining would be New Jersey (No. 1) and Indiana (No. 2), and New Jersey, as the top seed remaining may select either team from the bottom half of the remaining seeds. Indiana would play the team that was not picked.

In still another alternative embodiment of the invention, the top-seeded participant can select any other participant, whether seeded or not, whether the selected participant is in the top half or bottom half of participants. The next highest seeded participant not selected would then select next and so on until all the pairings are set.

In this alternative embodiment and returning to the initial eight team example above, Miami, the No. 1 seed, may select Indiana, the No. 2 seed, as its next round opponent. Milwaukee, the No. 3 seed, would select next.

In still another alternative embodiment of the invention, only the top half of the participants are pre-seeded, and the bottom half of the participants receive their seed values from the selections of the pre-seeded participants. In this case, the participant selected by the top seed would receive the lowest seed value and the participant selected by the second seed would receive the second lowest seed. This seeding is continued until all the selections are made. Hence, in returning to the initial eight team example above, Miami, the No. 1 seed, having selected New Jersey, New Jersey would be deemed to be the No. 8 seed.

In another alternative embodiment of the invention, after a round, the participants are re-seeded based on their performance in that round. This re-seeding or re-ranking may be performed by a combination of their performance in that round and some or all of the previous rounds, by random, or by some other method. For example, the participants can be re-seeded based on their success in a previous round using a margin of victory as a criterion. Thus, for the initial eight team example shown above, if New Jersey won its first-round match over Miami by 5 points; Indiana won its first round match over Chicago by 21 points; Milwaukee won its match over Cleveland by 7 points; and Detroit won its match over New York by 3 points, the four seeds that would be remaining are:

Indiana, the No. 1 seed

Milwaukee, the No. 2 seed

New Jersey, the No. 3 seed

Detroit, the No. 4 seed

Thus, the two top seeds that are remaining would be Indiana (No. 1) and Milwaukee (No. 2), and Indiana, the top seed remaining, can select either team from the bottom half of the remaining seeds, and Milwaukee would play the team that was not picked.

In yet another alternative embodiment of the invention, the invention disclosed may be implemented in a tournament where at least one of the teams receives a bye, i.e., a pass not to compete in a designated round of competitive events. For example, in the National Football League (NFL), the winners of two six-team tournaments compete in the Super Bowl. The six-team tournaments are constructed so that the No. 3 through No. 6 seeds compete in the first round, while the No. 1 and No. 2 seeds receive byes in the first round and automatically advance to the second round. This aspect of the invention may be used in the first round, with the No. 3 seed selecting its opponent from the No. 5 or No. 6 seeds, and the No. 4 seed playing the remaining opponent. Moreover, this invention may be used again in the second round, with the No. 1 seed selecting its opponent from the two first-round winners, and the No. 2 seed playing the remaining opponent.

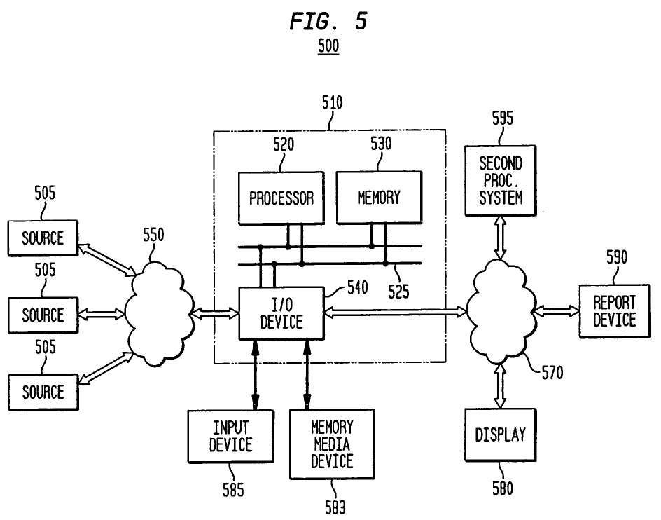

FIG. 4 illustrates a flow chart of an exemplary process 400 for selection of competitive pairs when a “bye” is imposed in the selection process. In this exemplary process, at block 410 the participants selected as having a “bye” are organized into a first group and at block 420 the remaining participants are organized into a second group. In a preferred embodiment, each of the participants has an associated rank order. At block 430, a first participant or entry or entity, preferably the highest rank entry, is selected. At block 440, one of the remaining entries in the second group is associated with the selected entry. At block 450, the two participants are marked as a competitive pair. At block 460, a determination is made whether more entries exist within the second group. If the answer is in the affirmative, a next, unmarked, participant or entry in the second group is selected at block 470. Preferably, the next participant is selected in the order of the associated ranking. Process then continues at block 440 to associate an entry with the selected participant. When all entries in the second group are marked as competitive pairs, processing is ended.

In still another aspect of the invention, less than half but at least one of the participants in a tournament are seeded. In the first round of the event, each of the seeded participants selects its opponent from among the unseeded participants, with each participant selecting in order of its placement or seed value. The unselected participants remaining after the selections by the seeded-participants are randomly paired, or paired pursuant to another method. The winners of the first round contests move on to the second round of the event, while the losers of the first round contests are eliminated. In the second round of the event, each of the remaining seeded participants selects its opponent from the remaining unseeded participants, with each participant selecting in order of its placement or seed value except that if the seeded participants comprise more than half of the remaining participants, then only each participant in the top half of the remaining participants would select its opponent, with each participant selecting in order of its placement or seed value, with each of these participants selecting its opponent from among the bottom half of the remaining participants. If there are unselected participants remaining after the selections by the seeded participants, these unselected participants are randomly paired, or paired pursuant to another method. The winners of the second round contests move on to the third round of the event, if sufficient competitors remain, while the losers of the second round contests are eliminated. This pattern continues until only two participants are left, which then compete to determine the winner of the event.

For example, this aspect may be used for the U.S. Open tennis tournament, where 32 of the 128 participants are initially seeded. In the first round, each of the 32 seeded participants would select his opponent from among the 96 unseeded participants, with each participant selecting in order of his placement or seed value. The 64 unseeded participants who are not selected would then be paired randomly, or pursuant to another method. In a later round of the tournament, it is possible that the seeded participants may comprise more than half of the remaining participants. For instance, in the third round (round of 32), 20 of the 32 remaining participants could be seeded. In this case, each of the top half of the participants remaining (the 16 highest seeds remaining) would select their opponent, in order of placement or seed value, and each of these participants would select their opponent from the bottom half of the participants remaining (the 4 lowest seeds remaining and the 12 unseeded participants remaining).

In another example of this aspect, in a four-team competition, only one of the teams may be seeded. In the first round, the seeded team selects its opponent from among the three unseeded opponents. The two unseeded and unselected opponents then are paired together. The winners of the first round contests then compete to determine the winner of the event.

In still another alternative embodiment of the invention, the system may be modified so that the selection process is altered for each round. For example, in a first round, the system disclosed herein may be implemented, but in the second round the selection process may revert back to where the top seed remaining plays the lowest seed remaining, the second-top seeded team plays the second-lowest seeded team, etc. Alternatively, less than all of the seeds in the top half can be given the right to select their opponents. Accordingly, the top seed may have the right to pick its opponent, while the remaining participants are matched pursuant to another method. Alternatively, less than all of the seeds in the bottom half can be designated as vulnerable to being selected. For example, in an eight-team tournament, only the No. 1 and No. 2 seeds may be given the right to select their opponents in the first round, and these teams may be limited to selecting among the No. 6, No. 7 and No. 8 seeds.

In still another alternative embodiment of the invention, any combination of alternative embodiments of the method disclosed may be used.

FIG. 4 illustrates a system 400 for implementing the principles of the invention as depicted in the exemplary processing shown herein. In this exemplary system embodiment 400, input data is received from sources 405 over network 450 and is processed in accordance with one or more software programs executed by processing system 410. The results of processing system 410 may then be transmitted over network 470 for viewing on display 480, reporting device 490 and/or a second processing system 495.

More specifically, processing system 510 includes one or more input/output devices 440 that receive data from the illustrated source devices 405 over network 450. The received data is then applied to processor 420, which is in communication with input/output device 440 and memory 430. Input/output devices 440, processor 420 and memory 430 may communicate over a communication medium 425. Communication medium 425 may represent a communication network, e.g., ISA, PCI, PCMCIA bus, one or more internal connections of a circuit, circuit card or other device, as well as portions and combinations of these and other communication media. Processor 520 may be representative of a handheld calculator, special purpose or general purpose processing system, desktop computer, laptop computer, palm computer, or personal digital assistant (PDA) device, etc., as well as portions or combinations of these and other devices that can perform the operations illustrated herein.

In one embodiment, processor 420 may include code which, when executed, performs the operations illustrated herein. The code may be contained in memory 430, read or downloaded from a memory medium such as a CD-ROM or floppy disk represented as 483, or may be read from a magnetic or optical medium (not shown) which is accessible by processor 420, when needed, or provided by manual input device 485, such as a keyboard or a keypad entry. Information items provided by input device 485 and/or magnetic medium 583 may be accessible to processor 420 through input/output device 440, as shown. Further, the data received by input/output device 440 may be immediately accessible by processor 420 or may be stored in memory 430. Processor 420 may further provide the results of the processing shown herein to display 480, recording device 490 or a second processing unit 495 through I/O device 440.

As one skilled in the art would recognize, the terms processor, processing system, computer or computer system may represent one or more processing units in communication with one or more memory units and other devices, e.g., peripherals, connected electronically to and communicating with the at least one processing unit. Furthermore, the devices may be electronically connected to the one or more processing units via internal busses, e.g., ISA bus, microchannel bus, PCI bus, PCMCIA bus, etc., or one or more internal connections of a circuit, circuit card or other device, as well as portions and combinations of these and other communication media, or an external network, e.g., the Internet and Intranet. In other embodiments, hardware circuitry may be used in place of, or in combination with, software instructions to implement the invention. For example, the elements illustrated herein may also be implemented as discrete hardware elements or may be integrated into a single unit.

As would be understood, the operation illustrated in FIG. 5 may be performed sequentially or in parallel using different processors to determine specific values. Processor system 510 may also be in two-way communication with each of the sources 505 over one or more network connections from a server or servers over, e.g., a global computer communications network such as the Internet, Intranet, a wide area network (WAN), a metropolitan area network (MAN), a local area network (LAN), a terrestrial broadcast system, a cable network, a satellite network, a wireless network, or a telephone network (POTS), as well as portions or combinations of these and other types of networks. As will be appreciated, networks 550 and 570 may also be internal networks, e.g., ISA bus, microchannel bus, PCI bus, PCMCIA bus, etc., or one or more internal connections of a circuit, circuit card or other device, as well as portions and combinations of these and other communication media or an external network, e.g., the Internet and Intranet.

Although the present invention has been described with regard to a processing system, it should be understood that as there may be a limited number of participants in a contest, selection of competitive partners in accordance with the principles of the invention may occur using a simple writing instrument to execute the process disclosed on a piece of paper to record the winning and losing parties in each round of events.

While the present invention has been primarily described with regard to sporting events, such as football, baseball, basketball, etc., it will be appreciated that principles of the invention may similarly be applied to individually competitive sports, such as tennis and boxing. In another aspect, the present invention may be suitable for determining a winner in non-sport related competitive events, such as television game shows or “reality” shows, or gambling games, such as poker tournaments, or “rotisserie” sports competitions, where individuals may compete against one another in athletic, non-athletic events or a combination of athletic and non-athletic events. It will also be appreciated that the events may be the same or different for each round of the competition. It will also be appreciated that selected individuals within ranked teams of individuals may select individuals within non-ranked or lower-ranked teams of individuals.

Fundamental novel features of the present invention have been shown, described, and pointed out as applied to preferred embodiments. It will be understood that various omissions and substitutions and changes in the apparatus described, in the form and details of the devices disclosed, and in their operation, may be made by those skilled in the art without departing from the spirit of the present invention. It is also expressly intended that all combinations of those elements which perform substantially the same function in substantially the same way to achieve the same result are within the scope of the invention. Substitutions of elements from one described embodiment to another are also fully intended and contemplated.

I claim:

1. A method for determining competitive partners from among a plurality of participants in a selected one of a plurality of rounds in a competitive event wherein selected ones of said participants have an associated ranking, said method comprising the steps of:
selecting, in accordance with said associated ranking, one of said participants,
allowing said selected participant to select one of said other participants; and
removing said selected participant and selected other participant from further consideration for said selected round,

2. The method as recited in claim 1, further comprising:
organizing said participants into a first group and a second group wherein each of said participants in said first group is associated with said ranking.

3. The method as recited in claim 2, further comprising:
associating a ranking with each of said participants in said second group.

4. The method as recited in claim 3, wherein said associated ranking is determined in accordance with completion of known events.

5. The method as recited in claim 4, wherein said known events are selected from the group consisting of: past competitive events among selected ones of said participants, accumulated results of past competitive events among selected ones of said participants, random selection, a lottery.

6. The method as recited in claim 1, wherein said competitive events are selected from the group consisting of: sporting events, television game shows, reality shows; intellectual games.

7. The method as recited in claim 1, further comprising the steps of:
recording a winning and a losing participant of an engagement from each of said selected participants and said selected other participants in said selected round; and
removing said losing participant from further participation in said competitive event.

8. The method as recited in claim 7, further comprising the step of:
allowing said winning participant of said round to retain said associated ranking.

9. The method as recited in claim 7, further comprising the step of:
allowing said winning participant of said competitive round to retain an associated ranking of said loser when said losing participant's associated ranking is higher.

10. The method as recited in claim 7, further comprising the step of:
assigning a ranking to each winning participant of said round based on performance in said round.

11. The method as recited in claim 1, wherein said round is selected from the group consisting of sporting events, game shows, reality shows, intellectual games.

12. The method as recited in claim 1, wherein said participants are selected from the group consisting of: individuals, teams of individuals.

13. The method as recited in claim 1, wherein each of said steps is executed until a single participant is remaining.

14. A method for operating a competitive event having a plurality of rounds among a plurality of competitors comprising the steps of:
a. determining a ranking for at least half of said plurality of competitors, wherein said ranking is associated with an order of selection;
b. selecting one of said ranked competitors in the order of said ranking;
c. allowing said selected ranked competitor to select one of said remaining competitors as a competitive partner;
d. continuously selecting said competitors until each of said competitors is associated with a competitive partner;
e. recording a winning and a losing competitor in an engagement of competitive partners in said round of competitive event;
f. removing said losing competitor from further participation; and
g. associating a new ranking with each remaining competitor.

15. The method as recited in claim 14, wherein said competitive event is selected from the group comprising: sporting events, game shows, reality shows, intellectual games.

16. The method as recited in claim 15, wherein said sporting events are selected from the group consisting of: baseball, football, soccer, basketball, racing, golf, boxing, tennis.

17. The method as recited in claim 14, wherein said ranking is determined from the group consisting of: prior performance, accumulated record in prior performance, a lottery, random selection.

18. The method as recited in claim 14, wherein said new ranking is selected from the group consisting of: maintaining a current associated ranking, obtaining a losing competitor's ranking.

19. The method as recited in claim 14, further comprising:
iteratively repeating steps a-g for each of said rounds.

20. The method as recited in claim 14, wherein said competitors are selected from the group consisting of: individuals, teams, individuals within a team.

21. A system for determining competitive partners from among a plurality of participants in a selected one of a plurality of rounds in a competitive event wherein at least one of said participants has an associated ranking, said system comprising:
means operable to execute code for:
selecting, in accordance with said associated ranking, one of said participants;
allowing said selected participant to select one of said other participants;
removing said selected participant and selected other participant from further consideration for said selected round; and
continuously selecting said participants until each of said participants is removed from further consideration.

22. The system as recited in claim 21, wherein said means is further operable to execute code for:
organizing said participants into a first group and a second group wherein each of said participants in said first group is associated with said ranking.

23. The system as recited in claim 22, wherein said means is further operable to execute code for:
associating a ranking with each of said participants in said second group.

24. The system as recited in claim 21, wherein said associated ranking is determined in accordance with completion of known events.

25. The system as recited in claim 24, wherein said known events are selected from the group consisting of: past competitive events among selected ones of said participants, accumulated results of past competitive events among selected ones of said participants, random selection, a lottery.

26. The system as recited in claim 21, wherein said competitive events are selected from the group consisting of: sporting events; television game shows; intellectual games.

27. The system as recited in claim 21, wherein said means is further operable for:
recording a winning and a losing participant of an engagement of each of said selected participants and said selected other participants in said selected round; and
removing said losing participant of said round from further participation in said competitive event.

28. The system as recited in claim 27, wherein said means is further operable for:
allowing said winning participant of said round to retain said associated ranking.

29. The system as recited in claim 27, wherein said means is further operable for:
allowing said winner participant of said competitive round to retain an associated ranking of said losing participant when said losing participant's associated ranking allows for earlier subsequent selection in a next round.

30. The system as recited in claim 27, wherein said means is further operable for:
assigning an associated ranking to each winner participant of said round based on its performance in said round.

31. The system as recited in claim 21, wherein said round is selected from the group consisting of sporting events, game shows, intellectual games.

32. The system as recited in claim 21, wherein said participants are selected from the group consisting of: individuals, teams of individuals, selected individuals within teams.

33. The system as recited in claim 21, further comprising:
means for receiving results of each of said competitive rounds.

34. The system as recited in claim 20, wherein said means is a processor in communication with a memory.

35. The system as recited in claim 33, wherein said processor is operable to execute code stored in said memory.

36. The system as recited in claim 21, wherein said means is a writing instrument in communication with a recording instrument.

37. The system as recited in claim 36, wherein said recording instrument is selected from the group consisting of: paper, touch sensitive electronic screen.

38. A method for determining competitive partners from among a plurality of participants in a selected one of a plurality of rounds in a competitive event wherein at least one of said participants has an associated ranking, said method comprising the steps of:
organizing at least one of said participants into a first group and remaining ones of said participants into a second group;
selecting, within said second group in accordance with said associated ranking, one of said participants,
allowing said selected participant to select one of said other participants; and
removing said selected participant and selected other participant from further consideration for said selected round.

39. The method as recited in claim 38, wherein each of said at least one of said participants in said first group has a higher associated ranking than each of said participants in said second group.

40. The method as recited in claim 38, wherein said associated ranking is determined in accordance with completion of known events.

41. The method as recited in claim 40, wherein said known events are selected from the group consisting of: past competitive events among selected ones of said participants, accumulated results of past competitive events among selected ones of said participants, random selection, a lottery.

42. The method as recited in claim 38, wherein said competitive events are selected from the group consisting of: sporting events; television game shows; reality shows; intellectual games.

43. The method as recited in claim 38, further comprising the steps of:
recording a winning and a losing participant of an engagement from each of said selected participants and said selected other participants in said selected round; and
removing said losing participant of said round from further participation in said competitive event.

44. The method as recited in claim 43, further comprising the step of:
allowing said winner participant of said round to retain said associated ranking.

45. The method as recited in claim 43, further comprising the step of:
allowing said winning participant of said competitive round to obtain an associated ranking of said loser when said loser's associated ranking is higher.

46. The method as recited in claim 43, further comprising the step of:
assigning an associated ranking to each winning participant of said round based on a performance in said round.

47. The method as recited in claim 38, wherein said round is selected from the group consisting of sporting events, game shows, reality shows, intellectual games.

48. The method as recited in claim 38, wherein said participants are selected from the group consisting of: individuals, teams of individuals.

49. The method as recited in claim 38, wherein said associated ranking of participants in said second group is determined randomly.
